(19) United States
(12) Patent Application Publication
(10) Pub. No.: US 2006/0212669 A1
(43) Pub. Date: Sep. 21, 2006

(54) Control method for storage system, storage system, storage control apparatus, control program for storage system, and information processing system

(75) Inventors: Koji Uchida, Kawasaki (JP); Hideaki Ohmura, Kawasaki (JP); Yoshinari Shinozaki, Kawasaki (JP); Mihoko Wada, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/239,056

(22) Filed: Sep. 30, 2005

(30) Foreign Application Priority Data
Mar. 17, 2005 (JP) 2005-076415

(51) Int. Cl. G06F 12/16

(52) U.S. Cl. 711/162

(57) ABSTRACT

The present invention provides a control method for a storage system comprising the first process for copying information stored by a first storage apparatus which is accessed by an upper echelon apparatus to a second storage apparatus, the second process for judging whether or not storage contents of the first and second storage apparatuses are identical when a fault occurs in the first storage apparatus, and the third process for controlling so that the upper echelon apparatus accesses the second storage apparatus in place of the first storage apparatus if the storage contents of the first and second storage apparatuses are identical.

### BACKGROUND OF THE INVENTION

1. Field of the Invention

The present invention relates to a control method for a storage system, a storage system, a storage control apparatus, a control program for a storage system and an information processing system; and in particular to an effective technique applicable to a fault recovery, and an operation, et cetera, for a redundantly comprised storage apparatus.

2. Description of the Related Art

In a storage apparatus such as a disk apparatus for example, it is desirable to store backup data as a duplication of the stored data in consideration of a hardware fault, et cetera. A copy function is used to make a backup for storage data of a discretionary range in a storage apparatus.

A storage apparatus, being used by a unit of logical volume for instance, will fall into a state of a host computer being unable to access a user volume if a fault occurs in the user volume allocated to a specific user.

In order to recover from a fault in the user volume, the recovery operation first recovers a fault in a disk apparatus comprising the user volume with an access from the host computer being halted, which is followed by completing the restoration and restarting an access to the user volume from the host computer.

This restoration work requires a conscious effort on the part of the manager of the storage apparatus, thus needing a considerable time for recovery.

The patent document 1 listed below has disclosed a backup switching control method, for use in an information processing system including a current use and spare equipment, in which a switching mechanism is furnished for carrying out a synchronization of processing by the currently used and spare equipment, a storage of fault information, a process time measurement, et cetera. And, the method is to notify an instruction for isolating the current use equipment from the system resource and an instruction for obtaining a dump in switching from the processing apparatus of the currently used equipment to that of spare equipment, and to carry out a spare equipment startup by isolating the currently used equipment forcibly if the time measurement function determines that a predetermined switching time has elapsed.

The patent document 1, however, has merely disclosed a switching of processing apparatuses and not a fault recovery processing by a use of backup data in a storage apparatus.

The patent document 2 has disclosed a technique to format a part of faulty disk medium in the minimum unit including the faulty spot when a fault occurs in a multiplexed disk apparatus, and to copy the data from another wholesome disk apparatus to the formatted part if the formatted part has no problem for data writing therein, followed by bringing the disk apparatus back on line.

The technique disclosed by the patent document 2, however, needs to isolate the CPU from the disk apparatus while the faulty disk medium is formatted and the data is copied, requiring an operation restart to wait for a recovery, which is no different from the conventional manual recovery operation.

The patent document 3 has disclosed a technique to connect a plurality of master disks in a switchable manner with a CPU unit and, if a freeze occurs during the operation by using one master disk, carry out a restart by switching to another master disk for connection with the CPU, thereby avoiding a recurrence of a system freeze due to a fault in a specific master disk.

In the case of patent document 3, however, an identity of data between master disks which are switched over at the freeze is not guaranteed, thus needing to wait until a completion of copying to be done in the background following the restart, and therefore an actual processing is not possible theretofore. Hence the above described technical issue associated with the conventional manual recovery operation cannot be solved.

[Patent document 1] Japanese patent laid-open application publication No. 06-348528

[Patent document 2] Japanese patent laid-open application publication No. 07-36629

[Patent document 3] Japanese patent laid-open application publication No. 2002-229742

### SUMMARY OF THE INVENTION

A purpose of the present invention is to provide a technique capable of transitioning to a continuous operation by using a backup data at a fault occurrence in a storage apparatus in a storage system which retains data multiplexed by a plurality of storage apparatuses.

Another purpose of the present invention is to provide a technique capable of transitioning to a continuous operation automatically by using a backup volume without requiring a user intervention at a fault occurrence in the user volume in a storage system which stores the user volume and a backup volume distributedly by a plurality of storage apparatuses.

A first aspect of the present invention is to provide a control method for a storage system, comprising the first process for copying information stored by a first storage apparatus which is accessed by an upper echelon apparatus to a second storage apparatus; the second process for judging whether or not storage contents of the first and second storage apparatuses are identical when a fault occurs in the first storage apparatus; and the third process for controlling so that the upper echelon apparatus accesses the second storage apparatus in place of the first storage apparatus if the storage contents of the first and second storage apparatuses are identical.

A second aspect of the present invention is to provide a storage system comprising an upper echelon interface control unit for connecting with an upper echelon apparatus; a lower echelon interface control unit for connecting with a plurality of storage apparatuses; an information transmission control unit for controlling exchange of information between the upper echelon and the storage apparatus; a copy control unit for carrying out the operations of copying the information from a first storage apparatus which is accessed by the upper echelon apparatus to another second storage apparatus and judging whether or not storage contents of the first and second storage apparatuses are identical; storage apparatus control unit for monitoring a presence or absence of fault in the storage apparatus; and a configuration control unit for switching the storage apparatus which is accessed by the upper echelon apparatus from the first storage apparatus to the second storage apparatus if the storage contents of the first and second storage apparatuses are identical when a fault occurs in the first storage apparatus.

A third aspect of the present invention is to provide a storage control apparatus for controlling an exchange of information between an upper echelon apparatus and a storage apparatus, comprising a copy unit for copying information stored by a first storage apparatus which is accessed by an upper echelon apparatus to a second storage apparatus; a judgment unit for judging whether or not storage contents of the first and second storage apparatuses are identical when a fault occurs in the first storage apparatus; and an access switching unit for controlling so that the upper echelon apparatus accesses the second storage apparatus in place of the first storage apparatus if the storage contents of the first and second storage apparatuses are identical.

A fourth aspect of the present invention is to provide a signal for carrying control program for a storage system which comprises a storage control apparatus for controlling an exchange of information between an upper echelon apparatus and a storage apparatus, wherein the control program makes the storage control apparatus carry out the first process for copying information stored by a first storage apparatus which is accessed by an upper echelon apparatus to a second storage apparatus; the second process for judging whether or not storage contents of the first and second storage apparatuses are identical when a fault occurs in the first storage apparatus; and the third process for making the upper echelon apparatus access to the second storage apparatus in place of the first storage apparatus if the storage contents of the first and second storage apparatuses are identical.

A fifth aspect of the present invention is to provide an information processing system, comprising an upper echelon apparatus; a plurality of storage apparatus storing information accessed by the upper echelon apparatus; and a storage control apparatus for controlling an exchange of the information between the upper echelon apparatus and the storage apparatus, wherein the storage control apparatus comprises a copy unit for copying information stored by a first storage apparatus which is accessed by an upper echelon apparatus to a second storage apparatus; a judgment unit for judging whether or not storage contents of the first and second storage apparatuses are identical when a fault occurs in the first storage apparatus; and an access switching unit for controlling so that the upper echelon apparatus accesses the second storage apparatus in place of the first storage apparatus if the storage contents of the first and second storage apparatuses are identical.

### BRIEF DESCRIPTION OF THE DRAWINGS

FIG. 1A is a conceptual diagram exemplifying a comprisal and working of an information processing system including a storage system according to an embodiment of the present invention;

FIG. 1B is a conceptual diagram exemplifying a comprisal and working of an information processing system including a storage system according to an embodiment of the present invention;

FIG. 2 is a conceptual diagram exemplifying an internal comprisal of a control storage constituting a storage system according to an embodiment of the present invention;

FIG. 3 is a conceptual diagram exemplifying a comprisal of cache memory constituting a storage system according to an embodiment of the present invention;

FIG. 4 is a conceptual diagram exemplifying a comprisal of host mapping table used by a storage system according to an embodiment of the present invention;

FIG. 5 is a conceptual diagram exemplifying a comprisal of session management table used by a storage system according to an embodiment of the present invention; and

FIG. 6 is a flow chart exemplifying a working of storage system and information processing system according to an embodiment of the present invention.

### DESCRIPTION OF THE PREFERRED EMBODIMENTS

The following is a detailed description of the preferred embodiment of the present invention while referring to the accompanying drawings.

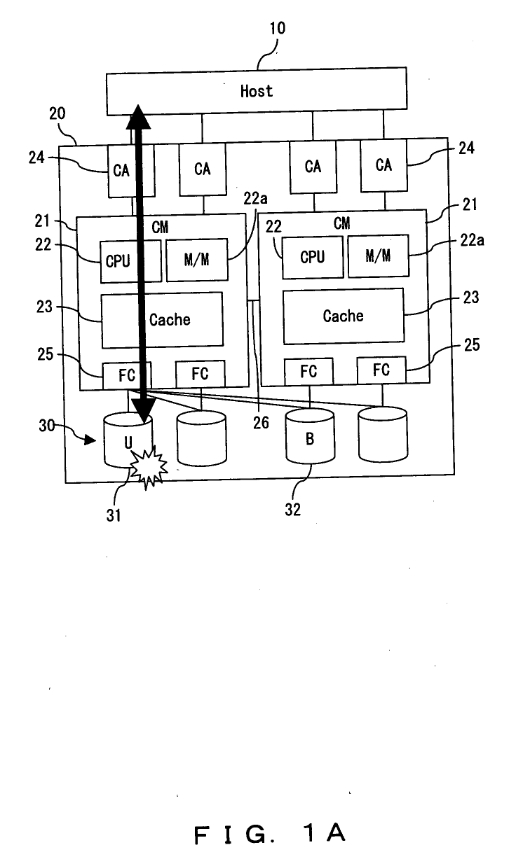

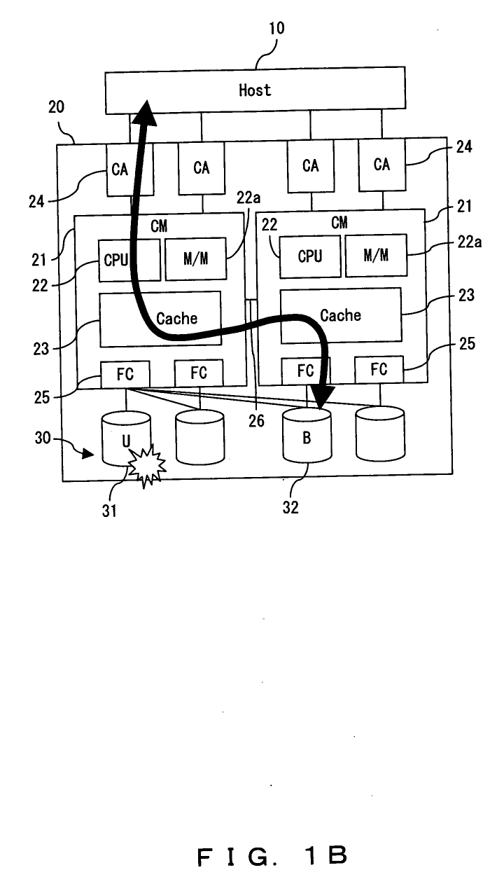

FIGS. 1A and 1B each is a conceptual diagram exemplifying a comprisal and working of information processing system including a storage system according to an embodiment of the present invention.

As exemplified by FIG. 1A, the information processing system includes a host computer 10 (i.e., upper echelon apparatus) and a subordinate storage system 20.

The storage system 20 includes a plurality of storage control apparatuses 21, a plurality of channel adaptors 24 and a plurality of disk apparatuses 30.

The channel adaptors 24 controls an exchange of information between the host computer 10 and storage control apparatus 21 based on a channel command issued by the host computer 10.

The storage control apparatuses 21 are dualized in the inside of the storage system 20. Each storage control apparatus 21 comprises a CPU 22, a control storage 22a, a cache memory 23 and disk adaptors 25.

The dualized pluralities of storage control apparatuses 21 are interconnected by a dualization path 26 to equalize the contents of cache memories 23 in each other's.

The CPU 22 controls the overall storage system 20 by executing a program stored by the control storage 22a.

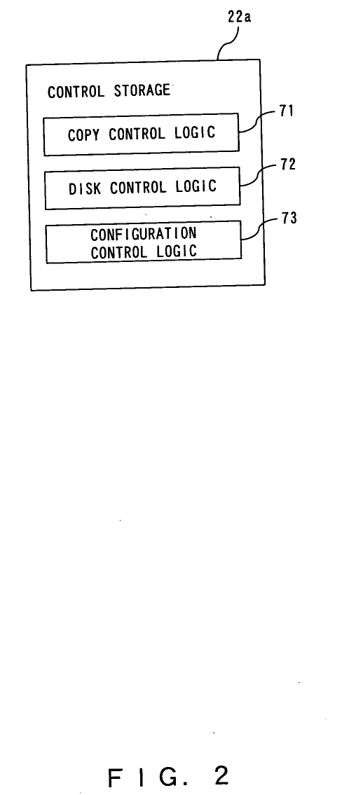

FIG. 2 is a conceptual diagram exemplifying an internal comprisal of the control storage 22a which is structured by a semiconductor memory for example and implemented by a series of control programs, i.e., a copy control logic 71 (i.e., copy control unit, or copy unit), a disk control logic 72 (i.e., storage apparatus control unit, or judgment unit) and a configuration control logic 73 (i.e., configuration control unit, or access switching unit).

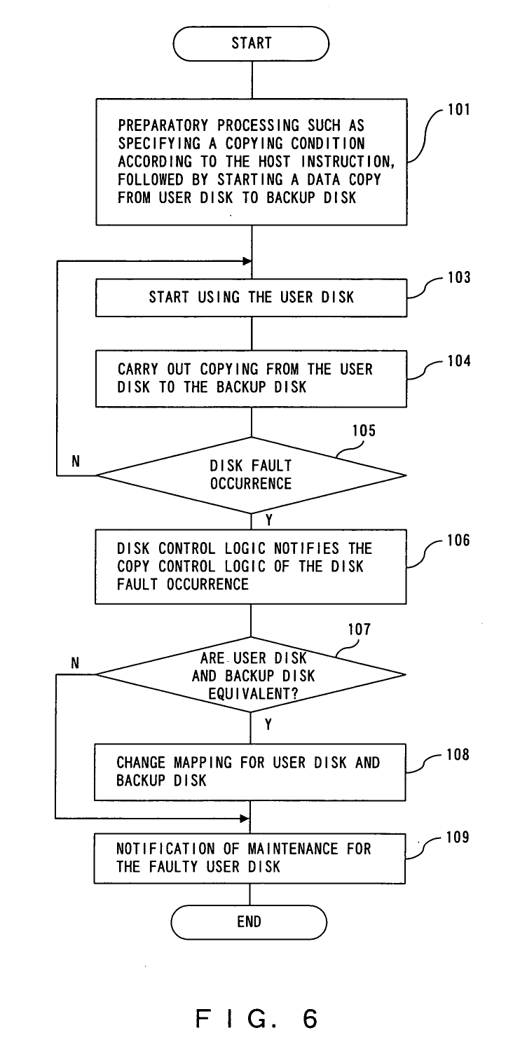

The CPU 22 carries out a control as exemplified by a later described flow chart shown by FIG. 6 by executing the series of programs, i.e., the above described copy control logic 71, disk control logic 72 and configuration control logic 73, by reading out of the control storage 22a.

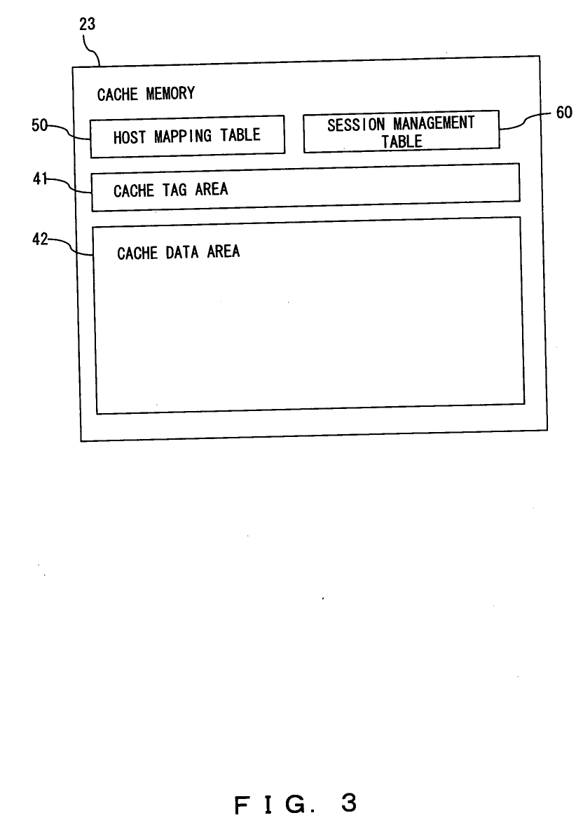

FIG. 3 is a conceptual diagram exemplifying a comprisal of the cache memory 23 which is structured by a semiconductor memory for example, comprising a cache tag area 41 and a cache data area 42. The cache data area 42 temporarily stores data exchanged between the host computer 10 and disk apparatuses 30. The cache tag area 41 stores information for managing data stored by the cache data area 42.

The cache memory 23 further stores a later described host mapping table 50 and session management table 60.

The disk adaptor 25 is constituted by an input & output interface such as a fiber channel (FC) to control an exchange of information between a plurality of disk apparatuses 30 and a storage control apparatus 21.

Each of a plurality of disk apparatus 30 is allocated by a user disk 31 (i.e., first storage apparatus) which is accessed by a user program implemented by the host computer 10 during a normal operation and allocated by a backup disk 32 (i.e., backup volume, or second storage apparatus which stores the same data as the user disk 31. There exist a plurality of user disks 31 and a plurality of backup disks 32. Physically different disk apparatuses are respectively allocated for the user disk 31 and backup disk 32.

The user disk 31 may physically be a disk apparatus 30 per se or a logical user volume built up therein.

Likewise, the backup disk 32 may physically be a disk apparatus 30 per se or a logical user volume built up therein.

An individual disk apparatus 30 which functions as a user disk 31 or backup disk 32 is identified by the host computer 10 by a logical unit number (LUN), and identified by an internal logical unit number (internal LUN) within the storage control apparatus 21.

For this, a host mapping table 50 is furnished in a part of the cache memory 23 for managing the LUN and internal LUN by relating with each other.

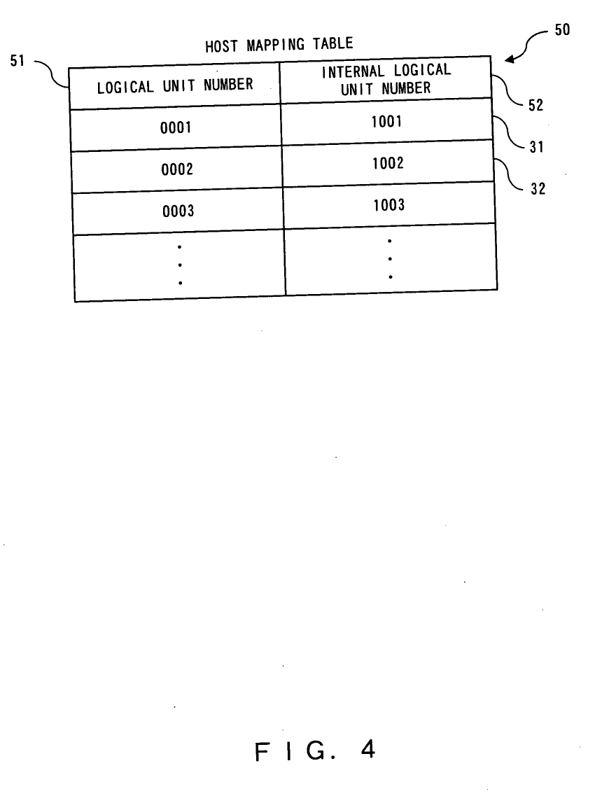

FIG. 4 is a conceptual diagram exemplifying a comprisal of host mapping table. Each disk apparatus 30 is stored by a logical unit number 51 (i.e., first identifier information) and internal logical unit number 52 (i.e., second identifier information) related with each other. The storage control apparatus 21 carries out an access request from the host computer 10 to a corresponding disk apparatus 30 based on the interrelationship between the logical unit number 51 and internal logical unit number 52 set in the host mapping table 50.

And the cache memory 23 comprises a session management table 60 which is used for managing the progress of copying data between the user disk 31 and the corresponding backup disk 32.

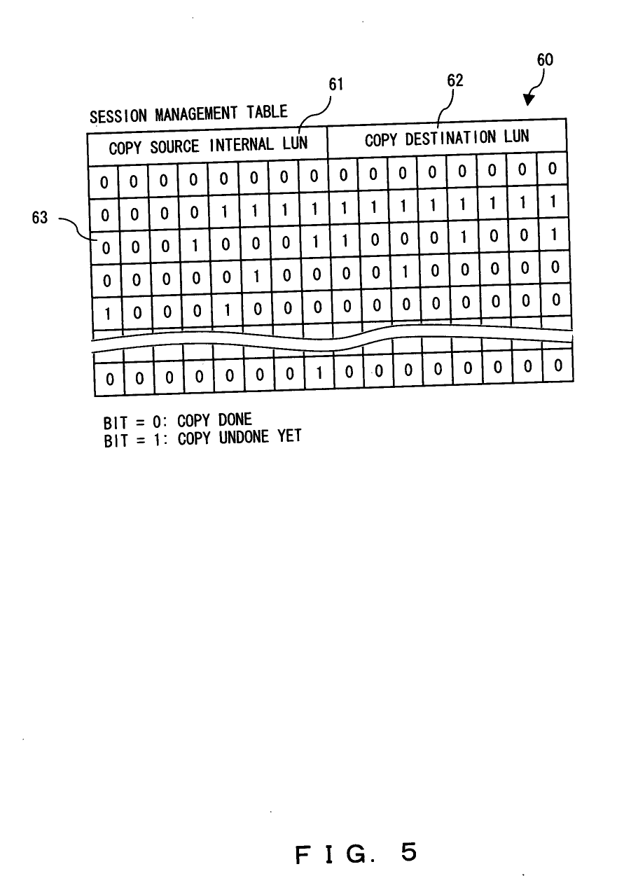

FIG. 5 is a conceptual diagram exemplifying a comprisal of the session management table 60 which stores a copy source internal logical unit number 61, a copy destination internal logical unit number 62 and a bit map 63.

The copy source internal logical unit number 61 is set by an internal LUN of the user disk 31. The copy destination internal logical unit number 62 is set by an internal LUN of the applicable backup disk 32 equipped corresponding to the aforementioned user disk 31.

The user disk 31 and backup disk 32 are managed for the presence or absence of data renewal by each of a plurality of unit storage areas which is identified by a logical block address (LBA). And the bit map 63 is made up of bit clusters set up for each of the plurality of unit storage areas. The one bit corresponding to a specific LBA (i.e., unit storage area) indicates whether or not a copying is done for a corresponding unit storage area on the side of the backup disk 32, indicating bit=“0” if copying is done, while bit=“1” if copying is undone yet.

Therefore, it is possible to judge whether or not the storage contents of the user disk 31 and backup disk 32 are identical by all the bits of the bit map 63 being “0” or not.

In the case of the present embodiment, the copy control logic 71 exemplified by the above described FIG. 2 manages a progress of data copy processing between the user disk 31 and backup disk 32. That is, as a copy processing from the user disk 31 to backup disk 32 by the unit of LBA is carried out, the progress of the copy processing will be recorded in the bit map 63 stored by the above described session management table 60.

And the copy control logic 71 judges whether or not the storage contents of the user disk 31 and backup disk 32 is identical by all the bits of the bit map 63 being “0” or not.

The above described disk control logic 72 comprises the function of controlling a data writing in, or reading out of, each disk apparatus 30 by way of the cache memory 23, and in addition, the function of monitoring a presence or absence of fault occurrence in the disk apparatus 30.

The above described configuration control logic 73 controls the setting of corresponding relationship (i.e., mapping) between the LUN (i.e., logical unit number 51) used by the host computer 10 for accessing a disk apparatus 30 and internal LUN (i.e., internal logical unit number 52) used by the storage control apparatus 21 for controlling a disk apparatus 30 for each disk apparatus 30 by setting or renewing the host mapping table 50 as exemplified by the above described FIG. 4.

Therefore, it is possible to switch access objects from the user disk 31 to the backup disk 32 without letting the host computer 10 be conscious about it, just by changing the corresponding relationship between the logical unit number 51 and internal logical unit number 52.

The next description is about an example working of the storage and information systems according to the present embodiment. FIG. 6 is a flow chart exemplifying a working of storage system and information processing system according to the present embodiment.

First of all, a preparatory processing is to specify a LUN for an object of copying according to an instruction from the host computer, et cetera. The copy control logic 71 creates a session management table and starts executing a copy from the user disk 31 to backup disk 32 (step 101).

An equivalent copy processing from the user disk 31 to backup disk 32 is carried out asynchronously with a host access.

Coincident with starting to carry out the copy, the host computer 10 starts accessing the user disk 31 (step 103). The copy control logic 71 reflects (i.e., copy) on the backup disk 32, a change of data in the user disk 31 associated with the host access (step 104).

During the period of the host computer 10 accessing the user disk 31, the disk control logic 72 monitors a presence or absence of fault occurrence in the user disk 31 (step 105).

And, if the disk control logic 72 detects a fault occurrence in the user disk 31, the disk control logic 72 notifies the copy control logic 71 of the fault occurrence therein (step 106).

In this event, the copy control logic 71 confirms whether or not the storage contents of the user disk 31 and backup disk 32 are equivalent (step 107).

And, if the storage contents of the user disk 31 and backup disk 32 are not equivalent, the disk control logic 72 reports a maintenance notification for the faulty user disk 31 to a system manager (step 109), and ends the processing.

If the judgment for the above described step 107 is that the storage contents of the user disk 31 and backup disk 32 are equivalent, the copy control logic 71 requests the configuration control logic 73 for changing a mapping of internal logical unit number 52 for the user disk 31 set in the host mapping table 50. The configuration control logic 73 changes the value of the internal logical unit number 52 for the user disk 31 from the value for the current user disk 31 to that for the backup disk 32. This enables the host computer 10 to access to the backup disk 32 automatically, without ever being conscious about it, and to continue operation of data input and output processing (step 108).

That is, the host computer 10 continues an I/O processing by switching the access objects from the user disk 31 to the backup disk 32 as shown by FIG. 1B.

Also, following changing the mapping in the step 108, report a maintenance notification for the faulty user disk 31 to the system manager (step 109).

As described above, if a fault occurs in a user disk 31, the present embodiment makes it possible to switch immediately, the accesses of the host computer 10 from the user disk 31 to the backup disk 32 without delay by judging whether or not the storage contents of the user disk 31 and backup disk 32 are equivalent, and, they are equivalent, changing the mapping of the internal logical unit number 52 for the user disk 31 set in the host mapping table 50 to that for the backup disk 32.

Also, the host computer 10 is enabled to access the backup disk 32 by using the same logical unit number 51 as before because the logical unit number 51 set in the host mapping table 50 does not change, and therefore the user program implemented by the host computer 10 has no need to be conscious about the host computer 10 changing the access objects from the user disk 31 to the backup disk 32.

Therefore, it is possible to transition to an operation by using a backup data without delay at the time of fault occurrence in a disk apparatus 30 in a storage system retaining data multiplexed by a plurality of disk apparatuses 30.

That is, it is possible to transition to an operation by using a backup volume without delay, without needing a user intervention, at the time of fault occurrence in a user volume in a storage system storing the user and back up volumes distributedly by a plurality of disk apparatuses 30.

Incidentally, it goes without saying that the present invention is not limited by the above described preferred embodiment but can be changed in a diverse way within the scope of the present invention.

The present invention makes it possible to continue an operation by using a backup data without delay at the time of fault occurrence in a storage apparatus in a storage system retaining data dualized by a plurality of storage apparatuses.

The present invention also makes it possible to transition to an operation automatically by using a backup disk without needing a user intervention at the time of fault occurrence in a user disk in a storage system storing the user and backup disks distributedly by a plurality of storage apparatuses.

What is claimed is:

1. A control method for a storage system, comprising:
the first process for copying information stored by a first storage apparatus which is accessed by an upper echelon apparatus to a second storage apparatus;
the second process for judging whether or not storage contents of the first and second storage apparatuses are identical when a fault occurs in the first storage apparatus; and
the third process for controlling so that the upper echelon apparatus accesses the second storage apparatus in place of the first storage apparatus if the storage contents of the first and second storage apparatuses are identical.

2. The control method for a storage system according to claim 1, wherein
first identifier information for said upper echelon apparatus to recognize said first or second storage apparatuses, and second identifier information for recognizing the first or second storage apparatuses within the storage system, are assigned to each of the first and second storage apparatuses, and
said third process controls so that the upper echelon apparatus accesses the second storage apparatus in place of the first storage apparatus by changing the second identifier information to a value corresponding to the second storage apparatus among a corresponding relationship between the first identifier information and the second identifier information relating to the first storage apparatus.

3. The control method for a storage system according to claim 1, wherein
said first and second storage apparatuses store said information by a block of unit storage area to which a logical block address is assigned, and
said second process judges whether or not copying said information is completed by a block of unit storage area which has the logical block address mutually corresponding between the first and second storage apparatuses, and determines an identity of storage contents in the first and second apparatuses if the information stored in all of the unit storage areas are identical.

4. A storage system comprising:
an upper echelon interface control unit for connecting with an upper echelon apparatus;
a lower echelon interface control unit for connecting with a plurality of storage apparatuses;
an information transmission control unit for controlling exchange of information between the upper echelon apparatus and the storage apparatus;
a copy control unit for carrying out the operations of copying the information from a first storage apparatus which is accessed by the upper echelon apparatus to another second storage apparatus and judging whether or not storage contents of the first and second storage apparatuses are identical;
a storage apparatus control unit for monitoring a presence or absence of fault in the storage apparatus; and
a configuration control unit for switching the storage apparatus which is accessed by the upper echelon apparatus from the first storage apparatus to the second storage apparatus if storage contents of the first and second storage apparatuses are identical when a fault occurs in the first storage apparatus.

5. The storage system according to claim 4, wherein
each of the first and second storage apparatuses comprises a mapping table in which first identifier information for said upper echelon apparatus to recognize each of said storage apparatuses and second identifier information for recognizing each of the storage apparatuses within the storage system are set up mutually related, and
said configuration control unit switches storage apparatuses which are accessed by the upper echelon apparatus from the first storage apparatus to the second storage apparatus by rewriting the second identifier to a value corresponding to the second storage apparatus among the first identifier information and the second identifier information set for the first storage apparatus in the mapping table.

6. The storage system according to claim 4, wherein
said first and second storage apparatuses store said information by a block of unit storage area to which a logical block address is assigned,
a session management table is comprised for judging whether or not copying said information is completed by a block of unit storage area which has the logical block address mutually corresponding between the first and second storage apparatuses, and
said copy control unit determines an identity of storage contents in the first and second apparatuses if the information stored in all of the unit storage areas are identical.

7. A storage control apparatus for controlling an exchange of information between an upper echelon apparatus and a storage apparatus, comprising:
a copy unit for copying information stored by a first storage apparatus which is accessed by an upper echelon apparatus to a second storage apparatus;
a judgment unit for judging whether or not storage contents of the first and second storage apparatuses are identical when a fault occurs in the first storage apparatus; and
an access switching unit for controlling so that the upper echelon apparatus accesses the second storage apparatus in place of the first storage apparatus if the storage contents of the first and second storage apparatuses are identical.

8. A signal for carrying a control program for a storage system comprising a storage control apparatus for controlling an exchange of information between an upper echelon apparatus and a storage apparatus, wherein
the control program makes the storage control apparatus carry out
the first process for copying information stored by a first storage apparatus which is accessed by an upper echelon apparatus to a second storage apparatus;
the second process for judging whether or not storage contents of the first and second storage apparatuses are identical when a fault occurs in the first storage apparatus; and
the third process for making the upper echelon apparatus access to the second storage apparatus in place of the first storage apparatus if the storage contents of the first and second storage apparatuses are identical.

9. The signal for carrying a control program for a storage system according to claim 8, wherein
first identifier information for said upper echelon apparatus to recognize said first or second storage apparatuses, and second identifier information for recognizing the first or second storage apparatuses within the storage system, are assigned to each of the first and second storage apparatuses, and
said third process controls so that the upper echelon apparatus accesses the second storage apparatus in place of the first storage apparatus by changing the second identifier information to a value corresponding to the second storage apparatus among a corresponding relationship between the first identifier information and the second identifier information relating to the first storage apparatus.

10. The signal for carrying a control program for a storage system according to claim 8, wherein
said first and second storage apparatuses store said information by a block of unit storage area to which a logical block address is assigned, and
said second process judges whether or not copying said information is completed by a block of unit storage area which has the logical block address mutually corresponding between the first and second storage apparatuses, and determines an identity of storage contents in the first and second apparatuses if the information stored in all of the unit storage areas are identical.

11. An information processing system, comprising:
an upper echelon apparatus;
a plurality of storage apparatus storing information accessed by the upper echelon apparatus; and
a storage control apparatus for controlling an exchange of the information between the upper echelon apparatus and the storage apparatus, wherein
the storage control apparatus comprises
a copy unit for copying information stored by a first storage apparatus which is accessed by an upper echelon apparatus to a second storage apparatus,
a judgment unit for judging whether or not storage contents of the first and second storage apparatuses are identical when a fault occurs in the first storage apparatus, and
an access switching unit for controlling so that the upper echelon apparatus accesses the second storage apparatus in place of the first storage apparatus if the storage contents of the first and second storage apparatuses are identical.

12. The information processing system according to claim 11, wherein
first identifier information for said upper echelon apparatus to recognize said first or second storage apparatuses, and second identifier information for recognizing the first or second storage apparatuses within the storage system, are assigned to each of the first and second storage apparatuses, and
said access switching unit controls so that the upper echelon apparatus accesses the second storage apparatus in place of the first storage apparatus by changing the second identifier information to a value corresponding to the second storage apparatus among a corresponding relationship between the first identifier information and the second identifier information relating to the first storage apparatus.

13. The information processing system according to claim 11, wherein
said first and second storage apparatuses store said information by a block of unit storage area to which a logical block address is assigned, and
said judgment unit judges whether or not copying said information is completed by a block of unit storage area which has the logical block address mutually corresponding between the first and second storage apparatuses, and determines an identity of storage contents in the first and second apparatuses if the information stored in all of the unit storage areas are identical.
